(19) United States
(12) Patent Application Publication
(10) Pub. No.: US 2010/0175515 A1
(43) Pub. Date: Jul. 15, 2010

(54) Wrench with releasable head

(76) Inventor: Ching Chen, Taichung (TW)

Correspondence Address: SAM CHEN, 7F-1, 293, ROOSEVELT ROAD, SEC 3, TAIPEI, TW

(21) Appl. No.: 12/351,813

(22) Filed: Jan. 10, 2009

(51) Int. Cl. B25B 23/16

(52) U.S. Cl. 81/177.85

(57) ABSTRACT

A wrench in one embodiment includes a handle comprising a head yoke and a spring depressible first detent disposed on the bottom of the head yoke; a positioning member comprising a projection pivotably secured to the head yoke, the projection having a notch on the outer surface which is urged by the first detent, a cavity opposite the projection, and a spring depressible second detent disposed on one side of the cavity; and a driving member comprising a protrusion having first and second recesses on both sides respectively, the protrusion being releasably mounted in the cavity with the second detent urging against one of the first and second recesses. The first detent is adapted to urge against the notch by pivoting the positioning member about the head yoke so as to dispose the positioning member at an inclined angle with respect to the head yoke.

### BACKGROUND OF THE INVENTION

1. Field of Invention

The invention relates to wrenches and more particularly to a wrench having a releasable, replaceable head (i.e., driving member) at only one end or a releasable, replaceable head at either end.

2. Description of Related Art

Wrenches are well known tools. One type of wrench is ratchet wrench. U.S. Pat. No. 6,769,329 ('329 patent) discloses a wrench having a releasable, replaceable head at one end. One drawback of the '329 patent is that only a socket of the size the same as the worn one can be used for replacement. In other words, it is impossible of replacing a worn socket of the wrench with another socket of a different size for driving function. Thus, the need for improvement still exists.

### SUMMARY OF THE INVENTION

It is therefore one object of the invention to provide a wrench having a releasable, replaceable head (i.e., driving member) at only one end or a releasable, replaceable head at either end.

The above and other objects, features and advantages of the invention will become apparent from the following detailed description taken with the accompanying drawings.

### BRIEF DESCRIPTION OF THE DRAWINGS

FIG. 1 is an exploded view of the head of a first preferred embodiment of wrench according to the invention;

FIG. 2 is a front view of the assembled wrench;

FIG. 3 is a side elevation of the wrench of FIG. 2;

FIG. 4 is an enlarged sectional view of a lower portion of the wrench head shown in FIG. 2;

FIG. 5 is an enlarged view of the wrench head of FIG. 3;

FIG. 6 is a view similar to FIG. 4 for showing a possible mounting of one of three different heads as the driving member of the wrench; and

FIG. 7 is a front view of a second preferred embodiment of wrench according to the invention.

### DETAILED DESCRIPTION OF THE INVENTION

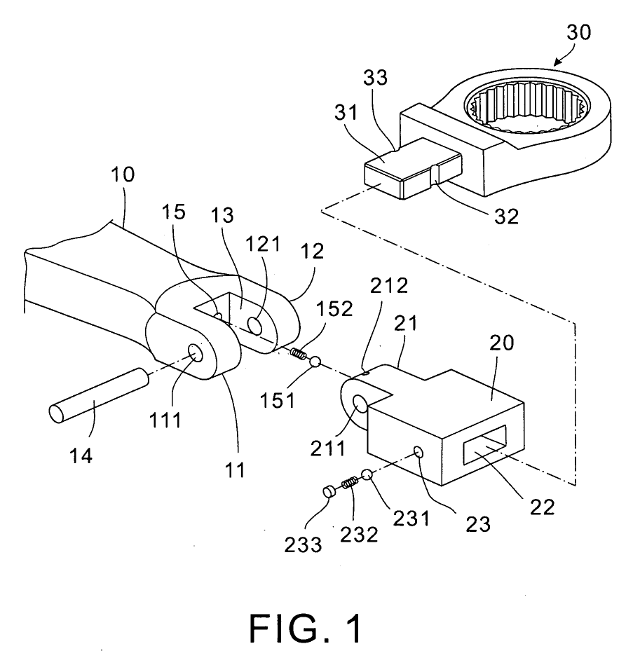

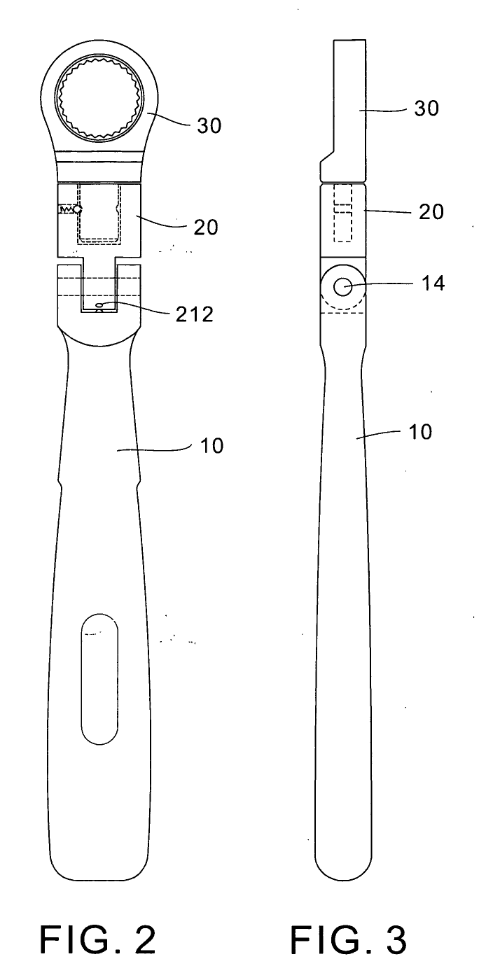

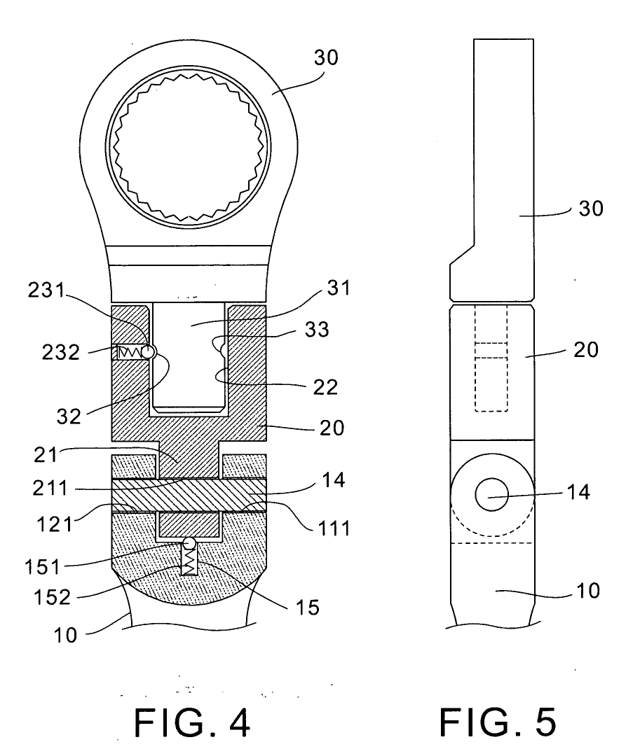

Referring to FIGS. 1 to 6, a wrench in accordance with a first preferred embodiment of the invention comprises the following components as discussed in detail below.

A handle 10 comprises first and second yoke arms 11, 12 at the head yoke. A space 13 is defined between the first and second yoke arms 11,12. The first yoke arm 11 has a through hole 111 open to the space 13 and the second yoke arm 12 has a through hole 121 aligned with the through hole 111. A lengthwise hole 15 is provided on the bottom of the recessed handle head and is open to the space 15. A helical compression spring 152 is disposed in the hole 15 and a steel ball 151 is provided on the exposed end of the spring 152.

A pivotal positioning member 20 comprises a projection 21 snugly fitted in the space 15, the projection 21 having a transverse through hole 211 and a notch 212 on the outer surface. The notch 212 is at a position higher than the through hole 211 (see FIG. 1). The pivotal positioning member 20% comprises a rectangular cavity 22 opposite the projection 21, and a transverse through hole 23 having one end open to the cavity 22 and the other end open to the outside. A cylindrical plug 233 is affixed to the outer end of the through hole 23. A helical compression spring 232 is disposed in the through hole 23 and rested upon the plug 233. A steel ball 231 is provided on one end of the spring 232 open to the cavity 22.

A driving member 30 comprises a parallelepiped protrusion 31 having first and second recesses 32, 33 on both sides of the protrusion 31 respectively.

An assembly of the invention will be described in detail below. A pivot pin 14 is inserted through the through holes 111, 211 and 121 to pivotably mount the pivotal positioning member 20 on the head yoke of the handle 10 in which the spring 152 expands to urge the steel ball 151 against the outer surface of the projection 21. The protrusion 31 is shaped to conform to the cavity 22 so that it is possible of inserting the protrusion 31 into the cavity 22 in which the spring 232 expands to urge the steel ball 231 against either one of the first and second recesses 32, 33 so as to secure the driving member 30 and the pivotal positioning member 20 together.

Operations of the invention will be described in detail below. In one operation, a user may put the driving member 30 on a bolt head prior to fastening or unfastening. In the other operation, the user may pivot the pivotal positioning member 20 about the head yoke of the handle 10 until the spring depressible steel ball 151 moves into the notch 212 for anchoring. At this position, the pivotal positioning member 20 is inclined at an acute angle with respect to the head yoke of the handle 10. Hence, the wrench of the invention is adapted to operate in an inclined angle if such need arises.

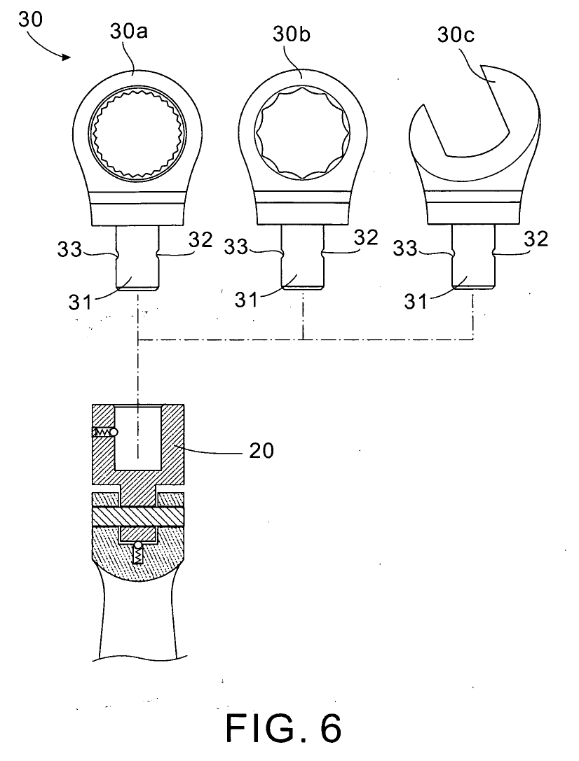

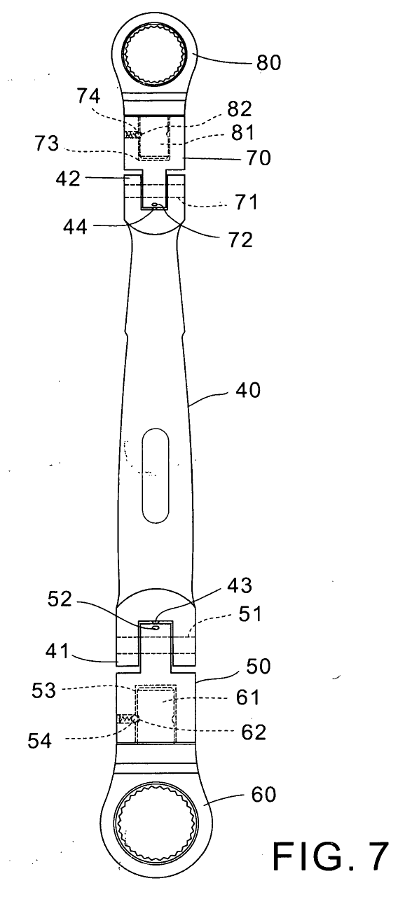

Referring to FIG. 6 specifically, the driving member 30 is releasable and replaceable. For example, the driving member 30 may be a first one 30a having ratchet teeth around its inner surface of its hollow, a second one 30b implemented as a box end, or a third one 30c implemented as an open end. Hence, a wrench capable of having a driving member of varying sizes is obtained by the invention.

Referring to FIG. 7, a wrench in accordance with a second preferred embodiment of the invention is shown. The characteristics of the second preferred embodiment are detailed below.

At one end of the handle 40, there are provided a head yoke 41, a spring depressible steel ball 43 provided on the bottom of the recessed head yoke 41; a pivotal positioning member 50 comprising a projection (not numbered) snugly fitted in the recessed head yoke 41, a pivot pin 51 inserted through the transverse through holes of the recessed head yoke 41 and the transverse through holes of the projection of the pivotal positioning member 50 to pivotably mount the pivotal positioning member 50 on the head yoke 41 of the handle 40 in which the steel ball 43 is urged against the outer surface of the projection of the pivotal positioning member 50, a notch 52 formed on the outer surface of the projection of the pivotal positioning member 50, a rectangular cavity 53 opposite the projection of the pivotal positioning member 50, and a spring depressible steel ball 54 partially projecting into the cavity 53; and a driving member 60 comprising a parallelepiped protrusion 61 having recesses 62 on both sides of the protrusion 61.

Assembly of the above components and operations of the wrench are the same as that described in the first preferred embodiment. Accordingly, further description is omitted for purposes of brevity and convenience only, and is not limiting.

At other end of the handle 40, there are provided a head yoke 42, a spring depressible steel ball 44 provided on the bottom of the recessed head yoke 42; a pivotal positioning member 70 comprising a projection (not numbered) snugly fitted in the recessed head yoke 42, a pivot pin 71 inserted through the transverse through holes of the recessed head yoke 42 and the transverse through holes of the projection of the pivotal positioning member 70 to pivotably mount the pivotal positioning member 70 on the head yoke 42 of the handle 40 in which the steel ball 44 is urged against the outer surface of the projection of the pivotal positioning member 70, a notch 72 formed on the outer surface of the projection of the pivotal positioning member 70, a rectangular cavity 73 opposite the projection of the pivotal positioning member 70, and a spring depressible steel ball 74 partially projecting into the cavity 73; and a driving member 80 comprising a parallelepiped protrusion 81 having recesses 82 on both sides of the protrusion 81.

Assembly of the above components and operations of the wrench are the same as that described in the first preferred embodiment. Accordingly, further description is omitted for purposes of brevity and convenience only, and is not limiting.

While the invention herein disclosed has been described by means of specific embodiments, numerous modifications and variations could be made thereto by those skilled in the art without departing from the scope and spirit of the invention set forth in the claims.

What is claimed is:

1. A wrench comprising:
a handle comprising a head yoke and a spring depressible first detent disposed on the bottom of the head yoke;
a positioning member comprising a projection pivotably secured to the head yoke, the projection having a notch on the outer surface which is urged by the first detent, a cavity opposite the projection, and a spring depressible second detent disposed on one side of the cavity; and
a driving member comprising a protrusion having first and second recesses on both sides respectively, the protrusion being releasably mounted in the cavity with the second detent urging against one of the first and second recesses,
wherein the first detent is adapted to urge against the notch by pivoting the positioning member about the head yoke so as to dispose the positioning member at an inclined angle with respect to the head yoke.

2. The wrench of claim 1, wherein each of the first and second detents is a steel ball.

3. A wrench comprising:
a handle comprising two head yokes and two spring depressible first detents each disposed on the bottom of either head yoke;
two positioning members each comprising a projection pivotably secured to either head yoke, the projection having a notch on the outer surface which is urged by the first detent, a cavity opposite the projection, and a spring depressible second detent disposed on one side of the cavity; and
two driving members each comprising a protrusion having first and second recesses on both sides respectively, the protrusion being releasably mounted in the cavity with the second detent urging against one of the first and second recesses, wherein at either head yoke the first detent is adapted to urge against the notch by pivoting the positioning member about the head yoke so as to dispose the positioning member at an inclined angle with respect to the head yoke.

4. The wrench of claim 3, wherein each of the first and second detents is a steel ball.
